(19) United States
(12) Patent Application Publication
(10) Pub. No.: US 2014/0074480 A1
(43) Pub. Date: Mar. 13, 2014

(54) VOICE STAMP-DRIVEN IN-VEHICLE FUNCTIONS

(71) Applicants: Jesse T. Gratke, Royal Oak, MI (US); Bassam S. Shahmurad, Clinton Township, MI (US)

(72) Inventors: Jesse T. Gratke, Royal Oak, MI (US); Bassam S. Shahmurad, Clinton Township, MI (US)

(73) Assignee: GM GLOBAL TECHNOLOGY OPERATIONS LLC, Detroit, MI (US)

(21) Appl. No.: 13/610,155

(22) Filed: Sep. 11, 2012

(51) Int. Cl. G10L 11/00

(52) U.S. Cl. 704/275; 704/E11.001

(57) ABSTRACT

In-vehicle functions are implemented using a plurality of microphones disposed in a vehicle. Each of the microphones is disposed in a portion of the vehicle defined by a zone. The in-vehicle functions are also implemented via a central controller of the vehicle. The central controller includes a computer processor executing logic. The logic receive a voice communication from an individual via one of the microphones, identifies the zone in the vehicle occupied by the individual, identifies the individual by comparing a voice stamp from the voice communication to a database of voice stamps, and implements at least one vehicle electronic component in the zone based on user preferences associated with the voice stamp.

### FIELD OF THE INVENTION

The subject invention relates to in-vehicle functions and, more particularly, to voice stamp-driven in-vehicle functions.

### BACKGROUND

Vehicles today provide many features directed toward enhancing the operator and passenger experience. Some of these features provide functionality through various controls for maximizing the comfort and convenience of the vehicle occupants, e.g., providing the ability to control in-cabin air temperature, seating positions, lighting, and volume levels of an audio system. However, in many instances, an operator or passenger needs to readjust each of these controls when other passengers have previously occupied the vehicle and have adjusted the controls to suit their own preferences.

It would be desirable to provide a way for the vehicle to recognize a particular passenger using a voice stamp, and initiate directed functions through the vehicle based on the individual preferences of the passenger.

### SUMMARY OF THE INVENTION

In one exemplary embodiment of the invention a system for implementing in-vehicle functions is provided. The system includes a plurality of microphones disposed in a vehicle. Each of the microphones is disposed in a portion of the vehicle defined by a zone. The system also includes a central controller of the vehicle. The central controller includes a computer processor. Logic is executable by the computer processor. The logic is configured to implement a method. The method includes receiving a voice communication from an individual via one of the microphones, identifying the zone in the vehicle occupied by the individual, identifying the individual by comparing a voice stamp from the voice communication to a database of voice stamps, and implementing at least one vehicle electronic component in the zone based on user preferences associated with the voice stamp.

In another exemplary embodiment of the invention, a method for implementing in-vehicle functions is provided. The method includes receiving a voice communication from an individual via one of a plurality of microphones disposed in a vehicle, identifying the zone in the vehicle occupied by the individual, identifying the individual by comparing a voice stamp from the voice communication to a database of voice stamps, and implementing at least one vehicle electronic component in the zone based on user preferences associated with the voice stamp.

In yet another exemplary embodiment of the invention a computer program product for implementing in-vehicle functions is provided. The computer program product includes a storage medium having computer program instructions embodied thereon, which when executed by a computer processor, cause the computer processor to implement a method. The method includes receiving a voice communication from an individual via one of a plurality of microphones disposed in a vehicle, identifying the zone in the vehicle occupied by the individual, identifying the individual by comparing a voice stamp from the voice communication to a database of voice stamps, and implementing at least one vehicle electronic component in the zone based on user preferences associated with the voice stamp.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a block diagram of a system upon which in-vehicle functions may be implemented in accordance with an embodiment;

FIG. 2 is a plan view of a vehicle layout configured with zones for use in implementing the in-vehicle functions in accordance with an embodiment; and

FIG. 3 is a flow diagram describing a process for implementing in-vehicle functions in accordance with an embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, in-vehicle functions are provided. The in-vehicle functions provide the ability to identify a particular operator or passenger of a vehicle and to initiate directed functions through the vehicle without passenger input. In one embodiment, the directed functions include adjusting various electronic components of the vehicle according to known passenger preferences in response to identifying the operator or passenger using a voice stamp of the operator or passenger. A voice stamp may be likened to an audio ‘fingerprint’ of a person's unique voice characteristics. The voice stamp may be created, e.g., by instructing an individual to utter pre-defined phonetically balanced sentences that cover his/her voice spectrum, followed by performing a spectral analysis on the utterances. The result of the spectral analysis is a frequency response of the individual's voice, which is referred to herein as a voice stamp.

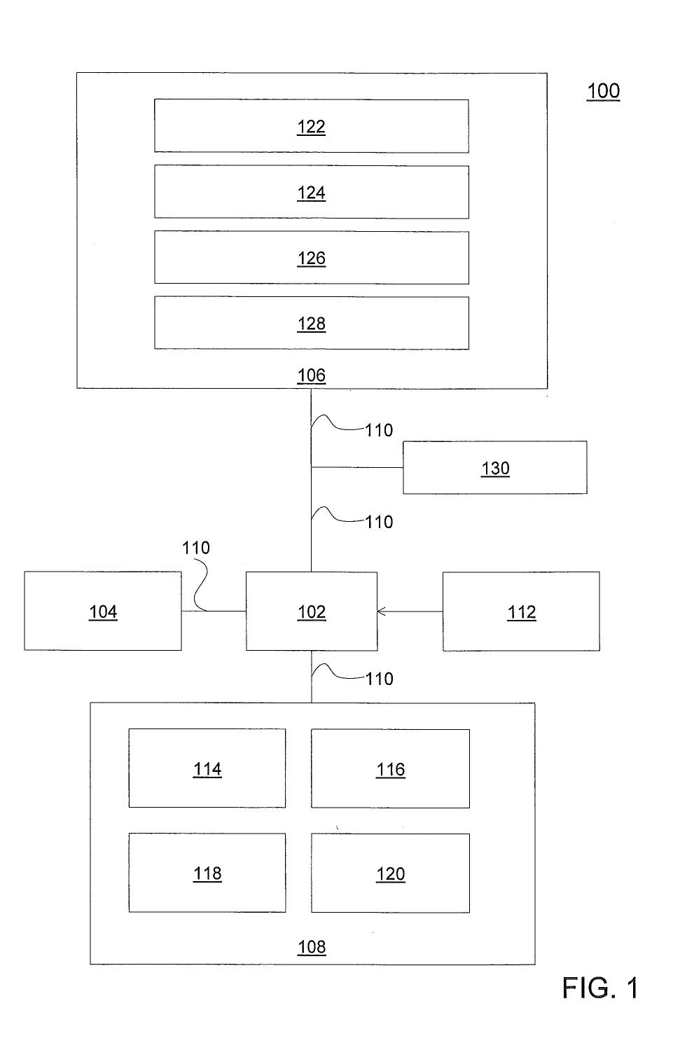

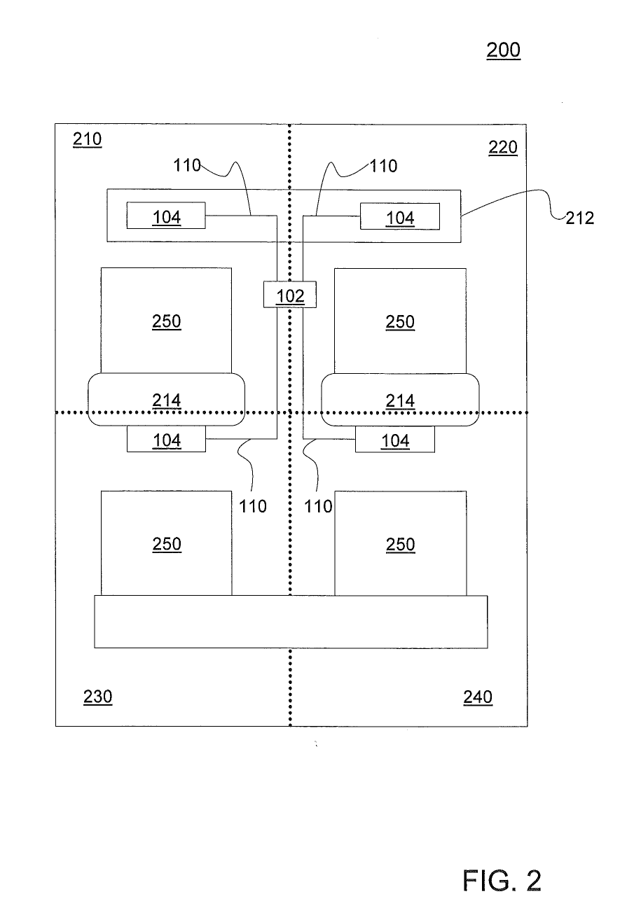

FIG. 1 illustrates a system 100 upon which the in-vehicle functions may be performed, and FIG. 2 illustrates a plan view of a vehicle 200 through which the in-vehicle functions may be implemented. Turning now to FIGS. 1 and 2, the system 100 and vehicle 200 will now be described in an exemplary embodiment. The vehicle 200 may be any type of automobile known in the art. As shown in FIG. 2, by way of non-limiting example, the vehicle 200 is a four-passenger vehicle designated by seats 250.

As shown in FIG. 1, the system 100 includes central controller 102 communicatively coupled to microphones 104, vehicle electronic components 106, memory 108, and input/output (I/O) components 130 via a vehicle network 110. The central controller 102 may include hardware and related circuitry configured to manage the vehicle electronic components 106 and for communicating therewith. In an embodiment, the central controller 102 is implemented using one or more computer processing devices.

The microphones 104 are disposed in designated areas of the vehicle 200 and receive voice communications from occupants seated therein. The microphones 104 transmit the voice communications to the central controller 102 for processing, as will be described herein. The microphones 104 may be any type of microphone, such as dynamic, piezoelectric, fiber optic, or laser, to name a few. In addition, the microphones 104 may employ noise cancellation capabilities. In one embodiment, the microphones 104 are wireless devices utilizing, e.g., radio transmission technology to communicate with the central controller 102.

The microphones 104 are dispersed in various passenger locations of the vehicle 200. For example, as shown in FIG. 2, by way of non-limiting example, microphones 104 corresponding to the front seat occupants are affixed to, or integrated with, the vehicle dashboard 212, and microphones 104 corresponding to back seat occupants are affixed to, or integrated with, head rests 214 of corresponding front seats 250. It will be understood that the microphones 104 may be disposed in any location that provides maximum signal quality of voice communications occurring in designated locations of the vehicle 200. For example, the microphones 104 may be disposed in B-Pillars of the vehicle (not shown) or the roof (not shown). As shown in FIG. 2, these locations are referred to as vehicle zones 1-4, and correspond to zones 210, 220, 230, and 240, respectively. As shown in FIG. 2, a front driver-side portion of the vehicle 200 corresponds to zone 210, and a front passenger-side portion of the vehicle 200 corresponds to zone 220. Zones 230 and 240 correspond to the rear portions of the vehicle 200 associated with the two rear passenger seating areas. In one embodiment, a single microphone 104 services each corresponding zone. However, it will be understood that multiple (e.g., two or more) microphones 104 may be employed in each zone in order to realize the advantages of the embodiments described herein.

The vehicle network 110 may be a physically wired network, a wireless network, or a combination thereof. In one embodiment, the vehicle network 110 is a local area network that communicatively couples vehicle electronic components 106 of the vehicle with the central controller 102. The vehicle electronic components 106 include, for example, a seating control system 122, a heating, ventilation, and air-conditioning (HVAC) system 124, an infotainment system 126, a lighting system 128, and input/output (I/O) components 130. Each of the vehicle electronic components 106 includes electronic control units (ECUs) (not shown), which may be implemented in hardware including related circuitry, as well as logic for facilitating communications between the vehicle electronic components 106 and the central controller 102.

The seating control system 122 includes physical controls for adjusting seat position for corresponding seats 250 in the vehicle 200. The ECU of the seating control system 122 receives signals via the physical controls as well as from the central controller 102 to perform a seat adjustment function (e.g., moving seat forward and backward, inclining and reclining seat back, and raising and lowering seat). If the vehicle seating 250 includes a heating component and/or a cooling component, the seat adjustment function may also include activating or adjusting the respective heating and/or cooling component.

The HVAC system 124 includes physical controls for adjusting the internal climate of designated portions (e.g., each of zones 210, 220, 230, and 240) of the vehicle 200 or its cabin area. The ECU of the HVAC system 124 receives signals via the physical controls as well as from the central controller 102 to perform an HVAC function (e.g., activating and deactivating the HVAC system 124, and increasing or decreasing temperature through a heating unit, as well as an air conditioning unit, activating and deactivating selected modes, such as floor vents only, main cabin, and turning on and off the rear HVAC if no passenger is present).

The infotainment system 126 includes physical controls for adjusting the functions of the infotainment system 126, such as turning on or off the system 126, increasing or decreasing audio volume levels, and tuning in preferred radio stations including applying radio presets for preferred radio stations. The ECU of the infotainment system 126 facilitates entertainment functions, such as playing recorded media through the system 126. The infotainment system 126 also includes speakers or other output means to provide music or programming through the radio or recorded medium.

The lighting system 128 includes physical controls for adjusting lighting levels for corresponding areas (e.g., zones 210, 220, 230, and 240) in the vehicle 200. The ECU of the lighting system 128 receives signals via the physical controls as well as from the central controller 102 to perform a lighting adjustment function (e.g., turning lights on and off, and dimming or brightening light levels).

The central controller 102 executes logic 112 for implementing the in-vehicle functions described herein. The central controller 102 is communicatively coupled to the memory 108 via the network 110. The memory 108 stores a zone database 114, pre-defined test phrases 116 for creating a voice stamp, a voice stamp database 118 for storing voice stamps 118 created for vehicle occupants, and a user preferences database 120 that stores settings of vehicle electronic components 106 selected by end users.

The logic 112 is preconfigured to establish and store identifiers for each of the zones 210, 220, 230, and 240 in the vehicle 200. Likewise, each zone is mapped to an identifier for each of the corresponding vehicle electronic components 106 and microphone(s) 104 that reside in that zone. A table of the mappings is stored in the zone database 114. Any unique identifiers may be used for this purpose.

In an embodiment, a vehicle owner, operator, or passenger (referred to herein as “end user”) may configure customized preferences for the vehicle electronic components 106 of the vehicle 200. The preferences may be stored in the memory 108 in the user preferences database 120 of the vehicle 200, along with an identifier of the end user's voice stamp. The end user may configure these settings using a variety of techniques. In one embodiment, the logic 112 may be configured to provide an interface via a display device in the vehicle (e.g., one or more of the I/O components 130 of the vehicle). In this embodiment, the end user may be prompted via the interface on the display of the vehicle to select from available settings associated with the vehicle components for the seating control system 122, the HVAC system, 124, the infotainment system 126, and the lighting system 128. A sample data structure format that may be used for storing these settings is shown below:

USER_VOICESTAMP_ID1
ELECTRONIC_COMPONENT_SETTING1
ELECTRONIC_COMPONENT_SETTING2 . . . .
ELECTRONIC_COMPONENT_SETTINGn

USER_VOICESTAMP_ID2 . . . .

USER_VOICESTAMP_IDn

As indicated above, the in-vehicle functions provide the ability to identify a particular operator or passenger of a vehicle by a voice stamp associated with the operator/passenger and to initiate directed functions through the vehicle 200. In one embodiment, the directed functions include adjusting various vehicle electronic components 106 of the vehicle 200 according to passenger preferences as determined using the voice stamp.

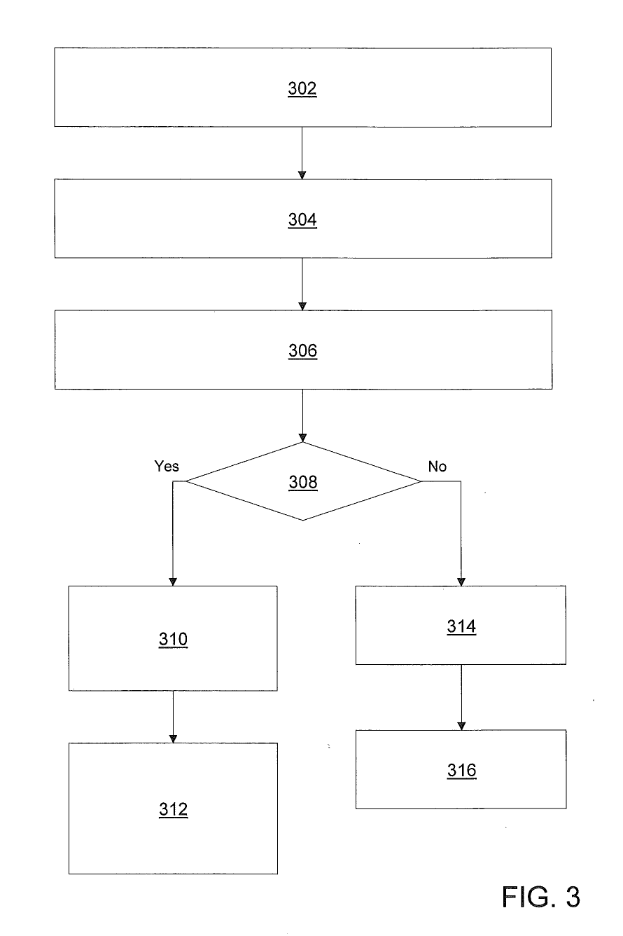

Turning now to FIG. 3, a flow diagram of a process for implementing in-vehicle functions in accordance with an embodiment will now be described. The process may begin at the initiation of a drive cycle or may begin at any time before, during, or after the drive cycle, so long as at least one passenger is in the vehicle. The vehicle may or may not be powered on.

At step 302, a microphone 104 is activated by an end user, e.g., through speech. The microphone 104 sends a signal to the central controller 102 that a voice has been detected. In one embodiment, the microphone 104 may also send it's identifier to the central controller 102. Using this identifier, the central controller 102 may determine which zone the voice came from.

At step 304, the logic 112 determines in which zone (e.g., zone 210, 220, 230, or 240) the end user is situated. As indicated above, this information may be derived from a microphone 104 identifier provided to the central controller 102 in response to detecting the voice. However, if two or more microphones 104 in different zones of the vehicle receive the voice data (e.g., when two microphones 104 detect the voice), the microphone 104 determined to have the strongest voice signal may be used to determine the zone. As indicated above, the zone is mapped to particular vehicle electronic components 106 that correspond to that zone (e.g., an air vent disposed in zone 4 (240)).

At step 306, the logic 112 creates a voice stamp from the voice detected in step 302, and uses the voice stamp to search the voice stamp database 118 of existing voice stamps for one that matches the signature of the newly-created voice stamp. The logic 112 may be configured to monitor the voice communication received at the microphone 104 and apply a spectral analysis (e.g., Fast Fourier Transform algorithm) over time until it correlates with the stored frequency response (i.e., an existing stored voice stamp).

At step 308, the logic 112 determines whether a match is found. If so, the logic 112 determines that existing user settings have been configured for the end user. The logic 112 uses an identifier of the voice stamp to search the user preferences database 120 for associated preferences (settings associated with the vehicle electronic components 106) at step 310. The logic 112 retrieves the user preferences and uses the zone identifier to implement the settings with respect to corresponding vehicle electronic components 106 for the end user at step 312.

For example, if the settings include seat position adjustments, the logic 112 is configured to communicate the seat position settings to the corresponding vehicle electronic component 106 (i.e., the seating control system 122) for the associated zone using the zone identifier derived from the microphone 104 located in the respective zone. If the settings are directed to the infotainment system 126, the logic 112 is configured to communicate any volume control, radio presets, etc., to the infotainment system 126 using the zone identifier derived from the microphone 104 located in the respective zone.

If, however, at step 308, the logic 112 does not find a match in the database 118, this may mean that no preferences have been established for this end user. The logic 112 retrieves pre-defined test phrases from the test phrases database 116 at step 314, and presents the test phrases to the end user with instructions to utter the phrases into the microphone 104 to create a voice stamp for the end user. The phrases may be presented in an audio format (e.g., through the speakers located in the zone, or may be presented in text form via a graphical user interface on a display screen (e.g., one of I/O components 130).

At step 316, the logic 112 creates a voice stamp from the spoken phrases it along with an identifier of the voice stamp in the voice stamp database 118. The user may select from any available settings for the vehicle electronic components 106, which may be identified by the logic 112 via communications received from the I/O components 130 and/or the vehicle controls associated with each of the vehicle electronic components 106. For example, if the zone identifier indicates the end user is sitting in the front passenger seat (e.g., zone 220), the HVAC system 124 that controls that portion of the vehicle 200 may be adjusted to the settings established for the end user (e.g., a climate control associated with a vent disposed in the front passenger side of the vehicle 200). At step 318, the logic 112 stores the selected settings in the user preferences database 120 and maps the voice stamp identifier from the voice stamp database 118 to the user preferences.

Technical effects of the invention include in-vehicle functions. The in-vehicle functions provide the ability to identify a particular operator or passenger of a vehicle using an individual's unique voice stamp and to initiate directed functions through the vehicle without passenger input. The directed functions include adjusting various vehicle components of the vehicle according to known passenger preferences.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

What is claimed is:

1. A system, comprising:
a plurality of microphones disposed in a vehicle, each of the microphones disposed in a portion of the vehicle defined by a zone;
a central controller of the vehicle, the central controller including a computer processor; and
logic executable by the computer processor, the logic configured to implement a method, the method comprising:
receiving a voice communication from an individual via one of the microphones;
identifying the zone in the vehicle occupied by the individual;
identifying the individual by comparing a voice stamp from the voice communication to a database of voice stamps; and
implementing at least one vehicle electronic component in the zone based on user preferences associated with the voice stamp.

2. The system of claim 1, wherein the microphones are disposed in at least one of a vehicle dashboard, headrests of vehicle seats, B-Pillars, and roof.

3. The system of claim 1, wherein the vehicle includes a display device and the logic is further configured to implement:
prompting the individual to select the user preferences with respect to the at least one vehicle electronic component;
storing the user preferences in a database; and
assigning an identifier to the voice stamp and mapping the identifier to the user preferences.

4. The system of claim 1, wherein the at least one vehicle electronic component includes at least one of:
vehicle seating;
heating, air-conditioning, and ventilation system components;
an infotainment system; and
lighting.

5. The system of claim 1, wherein the logic is configured to implement:
creating the voice stamp by receiving utterances from the individual, and performing a spectral analysis on a recording of the utterances.

6. The system of claim 5, wherein the utterances from the individual are based on pre-defined phonetically balanced sentences.

7. The system of claim 5, wherein the spectral analysis is a Fast Fourier Transform algorithm.

8. A method, comprising:
receiving, at a computer processor, a voice communication from an individual via one of a plurality of microphones disposed in a vehicle;
identifying the zone in the vehicle occupied by the individual;
identifying the individual using a voice stamp from the voice communication; and
implementing at least one vehicle component in the zone based on user preferences associated with the voice stamp.

9. The method of claim 8, wherein the microphones are disposed in at least one of a vehicle dashboard, headrests of vehicle seats, B-Pillars, and roof.

10. The method of claim 8, wherein the vehicle includes a display device, the method further comprising:
prompting the individual to select the user preferences with respect to the at least one vehicle electronic component;
storing the user preferences in a database; and
assigning an identifier to the voice stamp and mapping the identifier to the user preferences.

11. The method of claim 8, wherein the at least one vehicle electronic component includes at least one of:
vehicle seating;
heating, air-conditioning, and ventilation system components;
an infotainment system; and
lighting.

12. The method of claim 8, further comprising:
creating the voice stamp by receiving utterances from the individual, and performing a spectral analysis on a recording of the utterances.

13. The method of claim 12, wherein the utterances from the individual are based on pre-defined phonetically balanced sentences, and the spectral analysis is a Fast Fourier Transform algorithm.

14. A computer program product, the computer program product comprising a storage medium having computer program instructions embodied thereon, which when executed by a computer, cause the computer to implement a method, the method comprising:
receiving a voice communication from an individual via one of a plurality of microphones disposed in a vehicle;
identifying the zone in the vehicle occupied by the individual;
identifying the individual by comparing a voice stamp from the voice communication to a database of voice stamps; and
implementing at least one vehicle electronic component in the zone based on user preferences associated with the voice stamp.

15. The computer program product of claim 14, wherein the microphones are disposed in at least one of a vehicle dashboard, headrests of vehicle seats, B-Pillars, and roof.

16. The computer program product of claim 14, wherein the vehicle includes a display device and the logic is further configured to implement:
prompting the individual to select the user preferences with respect to the at least one vehicle electronic component;
storing the user preferences in a database; and
assigning an identifier to the voice stamp and mapping the identifier to the user preferences.

17. The computer program product of claim 14, wherein the at least one vehicle electronic component includes at least one of:
vehicle seating;
heating, air-conditioning, and ventilation system components;
an infotainment system; and
lighting.

18. The computer program product of claim 14, wherein the method further comprises:
creating the voice stamp by receiving utterances from the individual, and performing a spectral analysis on a recording of the utterances.

19. The computer program product of claim 18, wherein the utterances from the individual are based on pre-defined phonetically balanced sentences.

20. The computer program product of claim 18, wherein the spectral analysis is a Fast Fourier Transform algorithm.
